(19) United States
(12) Patent Application Publication
(10) Pub. No.: US 2017/0122010 A1
(43) Pub. Date: May 4, 2017

(54) SECURE FIREARM LOCK SYSTEM

(71) Applicant: John McCanna, Milk River (CA)

(72) Inventor: John McCanna, Milk River (CA)

(21) Appl. No.: 14/924,784

(22) Filed: Oct. 28, 2015

(51) Int. Cl. E05B 73/00; F41A 23/18; F42B 39/26

(52) U.S. Cl. CPC E05B 73/00; F42B 39/26; F41A 23/18

(57) ABSTRACT

A secure firearm lock system for the purpose of securing and displaying a firearm in the home affixed to any mountable surface. The secure firearm locking system is designed to allow a user to lock a firearm and ammunition in the same location while having the ability to showcase the weapon. The mountable design of the secure firearm lock system makes it ideal for mounting in many locations around the home, or a vehicle gun rack. The secure firearm lock system is designed for the convenience of having the ammunition in the same location as the firearm during an emergency situation. The secure firearm lock system is safe, secure, and easy to display while allowing an authorized user rapid access at any given time.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of firearm safety and more specifically relates to a mountable weapon locking device.

2. Description of Related Art

Many people own long barrel firearms for sport or protection, and having a place to store the firearm safely may prove to be a difficult task. An owner with children may not want to store their firearms where a child or intruder may easily obtain them. Other firearm owners may want to showcase their high dollar weapons but not allow guests to handle them. With the added threat of home invasions, owners may need a firearm securing method that allows a user to display and lock a weapon in the home, and not have the firearm tampered with. These owners also may desire to mount their firearm in different locations such as on a bedroom wall, or a bed frame for easy access in emergency situations. It is therefore desirable to have a wall mountable and displayable firearm locking system.

Several attempts have been made to solve the above-mentioned problems such as those found in U.S. and International Pub. And U.S. Pat. No. 7,448,156 to Jonathan Tucich; U.S. Pat. No. 6,142,313 to Kenneth David Young; U.S. Pat. No. 4,139,100 to Presley O. Reed; 2004/0129038 to Todd Vercoe; U.S. Pat. No. 8,450,086 to Jeremy Karst; WO 2009/141429 to Gottardo Gerotto; U.S. Pat. No. 5,339,966 to Richard G. Bastiaans; U.S. Pat. No. 3,802,612 to J. Smith; U.S. Pat. No. 5,887,730 to Charles St. George; U.S. Pat. No. 5,934,112 to David Rice et al; U.S. Pat. No. 6,427,497 to A. Iver Mossberg, Jr. et al; U.S. Pat. No. 7,047,771 to Laszlo Tanos; and U.S. Pat. No. 5,676,257 to John E. Adkins. This art is representative of firearm safety devices. However, none of the above inventions and patents, taken either singly or in combination, is seen to describe the invention as claimed.

Preferably, a secure firearm lock system should provide a means to securely lock and display a firearm yet allow for quick access to an authorized user and, yet would operate reliably and be manufactured at a modest expense. Thus, a need exists for a reliable secure firearm lock system to avoid the above-mentioned problems.

### BRIEF SUMMARY OF THE INVENTION

In view of the foregoing disadvantages inherent in the known firearm safety device art, the present invention provides a novel secure firearm lock system. The general purpose of the present invention, which will be described subsequently in greater detail is to provide a secure firearm lock system useful for storing a firearm safely, yet allowing quick access to an authorized user in an emergency situation.

The secure firearm lock system as disclosed herein in a preferred embodiment comprising: a secure firearm lock assembly having a first planar-surface mountable-support, a second planar-surface mountable-support, at least one locking apparatus, an ammunition storage container, and a planar-surface mountable barrel-cradle. The first planar-surface mountable-support and the planar-surface mountable barrel-cradle are able to be mounted horizontally and alternately vertically to a common plane to store the firearm.

The secure firearm lock assembly comprises in functional combination the first planar-surface mountable-support, the second planar-surface mountable-support, at least one locking apparatus, the ammunition storage container, and the planar-surface mountable barrel-cradle. The planar-surface mountable barrel-cradle comprises a hooked retaining member. The ammunition storage container when removably coupled to the first planar-surface mountable-support is structured and arranged to securely and horizontally store ammunition (for access); wherein the first planar-surface mountable-support further comprises a hinged latch for connection with a barrel lock coupled to the ammunition storage container. The first planar-surface mountable-support is vertically mounted via fasteners a distance apart from the planar-surface mountable barrel-cradle such that the firearm may be suitably stored.

The first planar-surface mountable-support and the second planar-surface mountable-support together form a hingeable yoke such that the first planar-surface mountable-support and the second planar-surface mountable-support are able to move relative to each other between an open and closed position as manipulated. The first planar-surface mountable-support comprises padding for supportively-protecting the firearm from damage (when closed/coupled) and the second planar-surface mountable-support comprises a pad for protecting the firearm from blemishes when the barrel is placed in contact with it. The hingeable yoke comprises a hinge, a securing arm, and an integrated trigger locking pin.

The first planar-surface mountable-support and the second planar-surface mountable-support, when closed, comprises a trigger guard rest, integrated trigger locking pin, with at least one locking apparatus that comprises means for securing the ammunition storage container and covering the trigger to prevent use thereof.

The ammunition storage container preferably has at least one locking apparatus comprising a barrel lock. The ammunition storage container comprises an (accessible) inner volume, an outer surface, a top, and a bottom; the top is openable by person(s) with authorized access such as a key or the like. The ammunition storage container is removably couplable to the first planar-surface mountable-support. The yoke and the planar-surface mountable barrel-cradle are structured and arranged such that a firearm and ammunition when placed therein can be mounted to a vertical surface for safe storage.

The first planar-surface mountable-support and the second planar-surface mountable-support when closed form a supportive neck to receive the trigger guard of the firearm, and the integrated trigger locking pin, preferably comprises a brass tube with a soft plastic tubing cover to protect the firearm trigger guard and trigger from abrasions in preferred embodiments. As such, the secure firearm lock system is structured and arranged for providing ready authorized access to said firearm and said ammunition storage container to an authorized user when needed and safe storage when not needed.

A kit is also disclosed herein including: the first planar-surface mountable-support, the second planar-surface mountable-support, the locking apparatus, the ammunition storage container, the planar-surface mountable barrel-cradle, and a set of user instructions. Keys and other kit items may also be included.

A method of using a secure firearm lock system is also described herein comprising the steps of: mounting the first planar-surface mountable-support and the second planar-surface mountable-support to a surface (such as a vertical wall); inserting a firearm into the first planar-surface mountable-support and the second planar-surface mountable-support; and locking the firearm in place. The method may further comprise the step of: locking ammunition into an ammunition storage container.

The present invention holds significant improvements and serves as a secure firearm lock system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, secure firearm lock system, constructed and operative according to the teachings of the present invention.

FIG. 1 shows a perspective view illustrating a secure firearm lock system during an ‘in-use’ condition according to an embodiment of the present invention.

FIG. 2 is a perspective view illustrating the secure firearm lock assembly of the secure firearm lock system according to an embodiment of the present invention of FIG. 1.

FIG. 3 is another perspective view illustrating the secure firearm lock system according to an embodiment of the present invention of FIGS. 1-2.

FIG. 4 is a perspective view illustrating the secure firearm lock system according to an embodiment of the present invention of FIGS. 1-3.

FIG. 5 is a perspective view illustrating the secure firearm lock system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to firearm safety and more particularly to a secure firearm lock system as used to improve the safety and accessibility of a firearm used for home protection.

Generally speaking, the secure firearm locking system may be mounted using bolts to a bedside board, a bed head-board, to a solid wall, or a gun rack in a vehicle. The ammunition box may be attached to the inside of the metal frame directly above the firearm trigger assembly, and will be provided with its own independent lock. The ammunition box may be manufactured in two sizes, one large enough for traditional shotgun shells, and the other size for a twenty round magazine. The integrated trigger locking pin is a brass rod with a removable soft plastic tubing. The secure firearm lock system can be mounted horizontally or vertically based on the needs of the user.

Preferred embodiments may comprise an inner padding to avoid abrasions to the firearm. Certain embodiments may also comprise at least one barrel lock, but may comprise a plurality of different locking mechanisms such as biometric, keypad, or combination, etc. The preferred embodiment also allows the secure firearm lock system to be installed at varying lengths to accommodate different size long-barreled weapons.

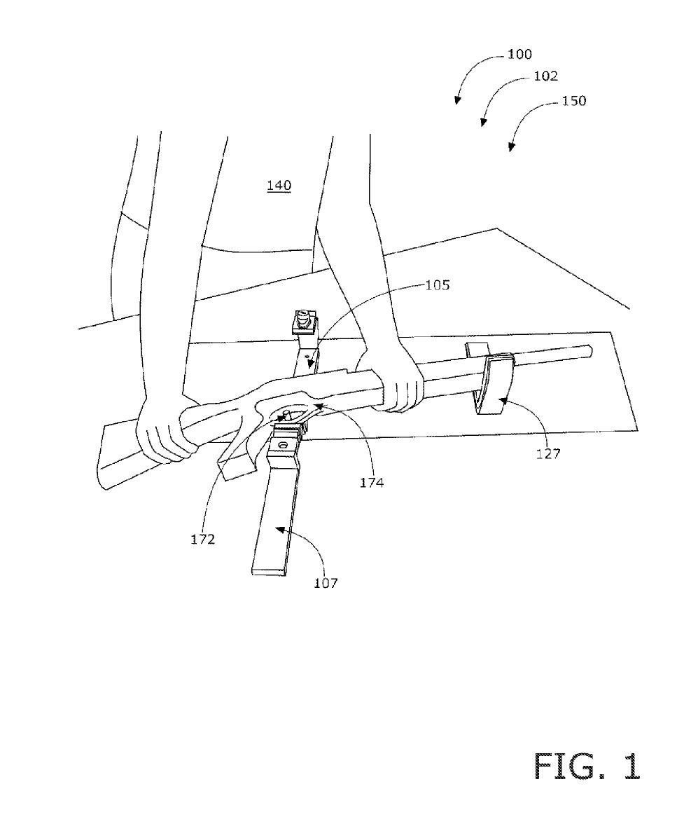

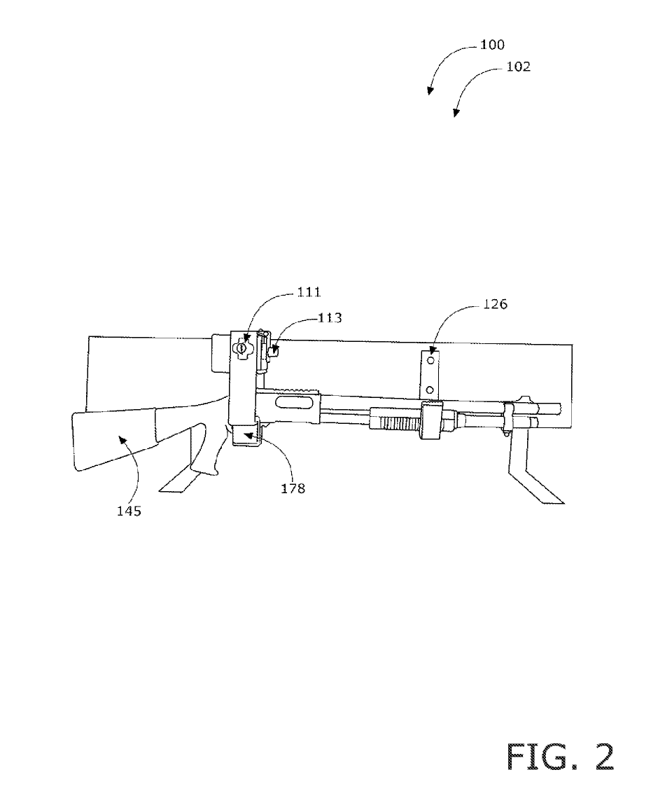

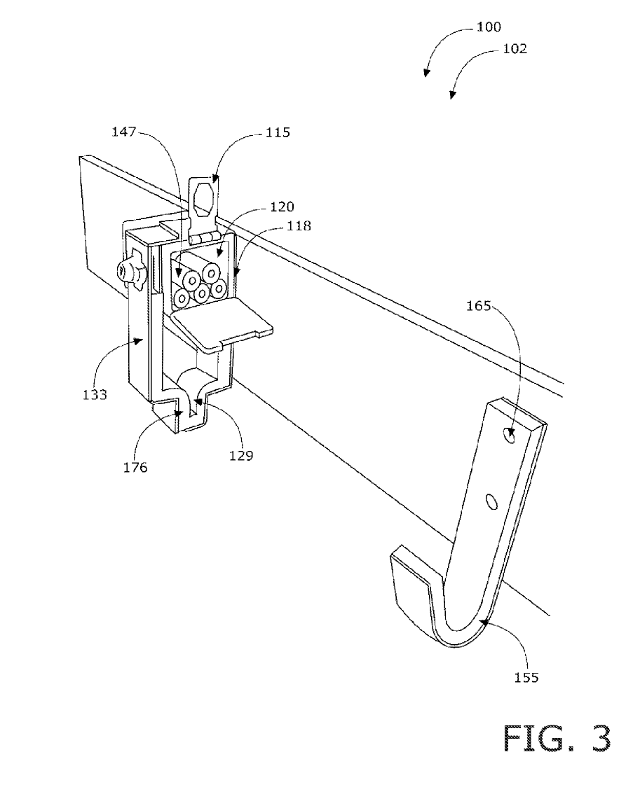

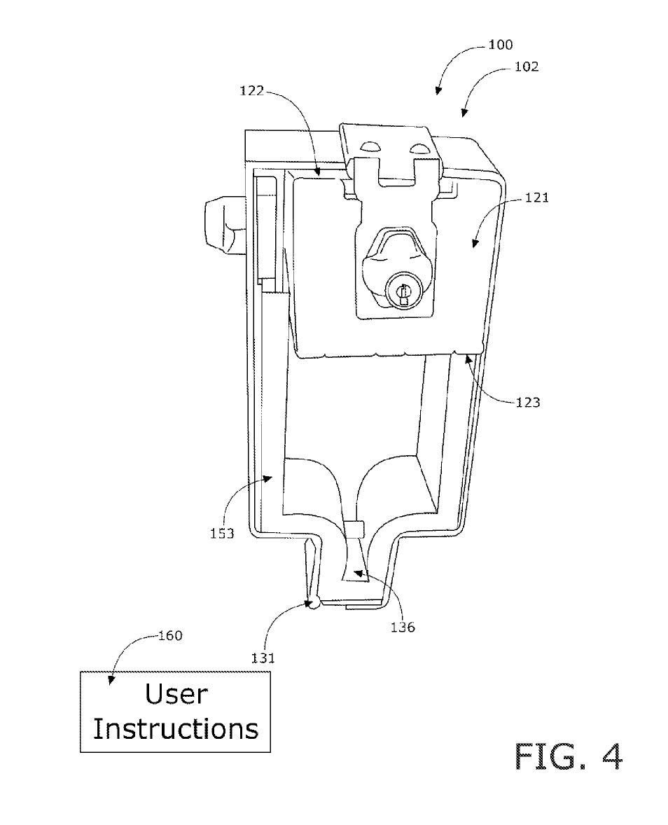

Referring to the drawings by numerals of reference there is shown in FIGS. 1-4 showing various views of secure firearm lock system 100 comprising: secure firearm lock assembly 102 comprising; first planar-surface mountable-support 105, second planar-surface mountable-support 107, at least one locking apparatus 111, ammunition storage container 118, and planar-surface mountable barrel-cradle 126, as such secure firearm lock system 100 comprises secure firearm lock assembly 102.

Secure firearm lock assembly 102 comprises in functional combination first planar-surface mountable-support 105, second planar-surface mountable-support 107, at least one locking apparatus 111, ammunition storage container 118, and planar-surface mountable barrel-cradle 126. First planar-surface mountable-support 105, and second planar-surface mountable-support 107 together form a hingeable yoke 129 such that first planar-surface mountable-support 105, and second planar-surface mountable-support 107 are able to move relative to each other between an open and closed position.

Hingeable yoke 129 comprises hinge 131, securing arm 133 and integrated trigger locking pin 136, and at least one locking apparatus 111 which comprises means for securing ammunition storage container 118 and covering trigger of firearm 145 to prevent use thereof. Ammunition storage container 118 comprises inner volume 120, outer surface 121, top edge 122, and bottom edge 123. Hingeable yoke 129 and planar-surface mountable barrel-cradle 126 are structured and arranged such that firearm 145 when placed therein can be mounted to a vertical surface for safe storage.

Planar-surface mountable barrel-cradle 126 comprises hooked retaining member 127; wherein secure firearm lock system 100 is structured and arranged for providing ready authorized access to firearm 145 and ammunition storage container 118 to an authorized user 140 when needed and safe storage when not needed. First planar-surface mountable-support 105 comprises padding 153 for supportively-protecting firearm 145 from damage. Second planar-surface mountable-support 107 comprises pad 155 for protecting firearm 145 from damage. Secure firearm lock system 100 comprises at least one locking apparatus 111 which also comprises barrel lock 113. In certain embodiments, the locking apparatus 111 may comprise a combination lock, a keypad lock, and/or a biometric lock or combination thereof.

Ammunition storage container 118 is removably couplable to first planar-surface mountable-support 105. Ammunition storage container 118 when removably coupled to first planar-surface mountable-support 105 is structured and arranged to securely and horizontally store ammunition 147. First planar-surface mountable-support 105 further preferably comprises hinged latch 115 for connection with barrel lock 113 coupled to ammunition storage container 118.

First planar-surface mountable-support 105 may be vertically mounted via fasteners 165 a distance apart from planar-surface mountable barrel-cradle 126. First planar-surface mountable-support 105 and planar-surface mountable barrel-cradle 126 occupy a common plane when mounted. First planar-surface mountable-support 105 and second planar-surface mountable-support 107, when closed, comprises integrated trigger locking pin 172. In the preferred embodiment, integrated trigger locking pin 172 comprises a brass tube with a soft plastic tubing to protect firearm trigger guard 174 and trigger from abrasions. Other suitable materials may be used. First planar-surface mountable-support 105 and second planar-surface mountable-support 107, when closed, form supportive neck 176 to receive trigger guard 178 of firearm 145. First planar-surface mountable-support 105 and planar-surface mountable barrel-cradle 126 is able to be mounted horizontally and alternately vertically to a common plane.

Secure firearm lock system 100 may be sold as kit 440 comprising the following parts: at least one first planar-surface mountable-support 105 at least one second planar-surface mountable-support 107; at least one locking apparatus 111; at least one ammunition storage container 118; at least one planar-surface mountable barrel-cradle 126; and at least one set of user instructions 160. The kit has instructions such that functional relationships are detailed in relation to the structure of the invention (such that the invention can be used, maintained, or the like in a preferred manner). Secure firearm lock system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

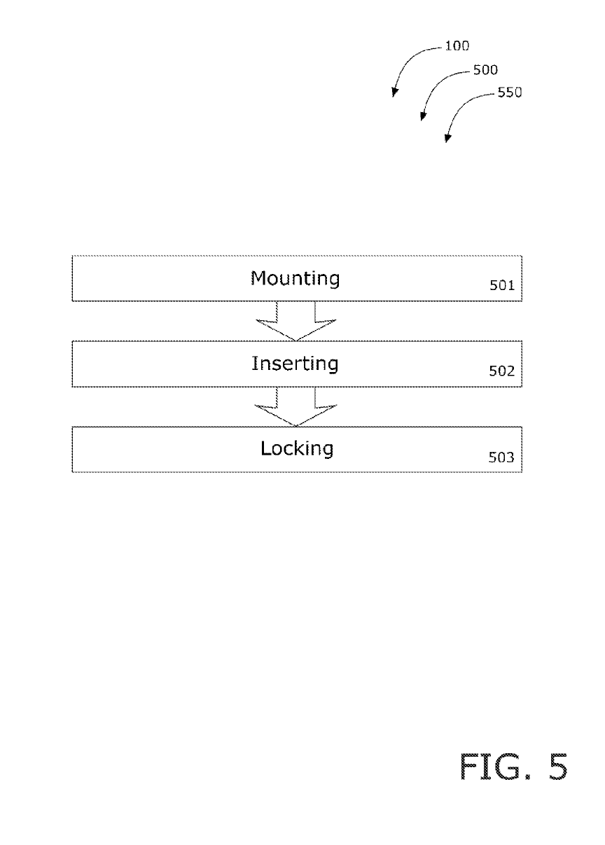

Referring now to FIG. 5 showing flowchart 550 illustrating method of use 500 for the secure firearm lock system 100 according to an embodiment of the present invention of FIGS. 1-4. As shown, method of use 500 may comprise the steps of: step one 501, mounting first planar-surface mountable-support 105 with second planar-surface mountable-support 107, and planar-surface mountable barrel-cradle 126 to a surface; step two 502, inserting firearm 145 into first planar-surface mountable-support 105 with second planar-surface mountable-support 107, and planar-surface mountable barrel-cradle 126; and step three 503, locking firearm 145 in place. The method 500 may further comprise the step of: step four 504, locking ammunition into ammunition storage container 118. The firearm 145 and ammunition may be removed and replaced as needed.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A secure firearm lock system comprising:
a secure firearm lock assembly comprising;
a first planar-surface mountable-support;
a second planar-surface mountable-support;
at least one locking apparatus;
an ammunition storage container;
a planar-surface mountable barrel-cradle; and
an integrated trigger locking pin.
wherein said secure firearm lock system comprises said secure firearm lock assembly;
wherein said secure firearm lock assembly comprises in functional combination said first planar-surface mountable-support, said second planar-surface mountable-support, said at least one locking apparatus, said ammunition storage container, and said planar-surface mountable barrel-cradle;
wherein said first planar-surface mountable-support and said second planar-surface mountable-support together form a hingeable yoke such that said first planar-surface mountable-support and said second planar-surface mountable-support are able to move relative to each other between an open and closed position;
wherein said hingeable yoke comprises a hinge, a securing arm, and a trigger support;
wherein said at least one locking apparatus comprises means for securing said ammunition storage container and covering said trigger to prevent use thereof;
wherein said ammunition storage container comprises an inner volume, an outer surface, a top edge, and a bottom edge;
wherein said yoke and said planar-surface mountable barrel-cradle are structured and arranged such that a firearm when placed therein can be mounted to a vertical surface for safe storage;
wherein said planar-surface mountable barrel-cradle comprises a hooked retaining member; and
wherein said secure firearm lock system is structured and arranged for providing ready authorized access to said firearm and said ammunition storage container to an authorized user when needed and safe storage when not needed.

2. The secure firearm lock system of claim 1 wherein said first planar-surface mountable-support comprises padding for supportively-protecting said firearm from damage.

3. The secure firearm lock system of claim 1 wherein said second planar-surface mountable-support comprises a pad for protecting said firearm from damage.

4. The secure firearm lock system of claim 2 wherein said at least one locking apparatus comprises a barrel lock.

5. The secure firearm lock system of claim 2 wherein said at least one locking apparatus comprises a combination lock.

6. The secure firearm lock system of claim 2 wherein said at least one locking apparatus comprises a keypad lock.

7. The secure firearm lock system of claim 2 wherein said at least one locking apparatus comprises a biometric lock.

8. The secure firearm lock system of claim 2 wherein said ammunition storage container is removably couplable to said first planar-surface mountable-support.

9. The secure firearm lock system of claim 2 wherein said ammunition storage container when removably coupled to said first planar-surface mountable-support is structured and arranged to securely and horizontally store ammunition.

10. The secure firearm lock system of claim 4 wherein said first planar-surface mountable-support further comprises a hinged latch for connection with said barrel lock coupled to said ammunition storage container.

11. The secure firearm lock system of claim 2 wherein said first planar-surface mountable-support is vertically mounted via fasteners a distance apart from said planar-surface mountable barrel-cradle.

12. The secure firearm lock system of claim 11 wherein said first planar-surface mountable-support and said planar-surface mountable barrel-cradle occupy a common plane when mounted.

13. The secure firearm lock system of claim 2 wherein said first planar-surface mountable-support and said second planar-surface mountable-support when closed comprises an integrated trigger locking pin.

14. The secure firearm lock system of claim 13 wherein said trigger guard rest and integrated trigger locking pin comprises a brass rod with a soft plastic tubing to protect said firearm trigger guard and trigger from abrasions.

15. The secure firearm lock system of claim 14 wherein said first planar-surface mountable-support and said second planar-surface mountable-support when closed form a supportive neck to receive said trigger guard of said firearm.

16. The secure firearm lock system of claim 2 wherein said first planar-surface mountable-support and said planar-surface mountable barrel-cradle is able to be mounted horizontally and alternately vertically to said common plane.

17. A secure firearm lock system comprising:
a secure firearm lock assembly comprising;
a first planar-surface mountable-support;
a second planar-surface mountable-support;
at least one locking apparatus;
an ammunition storage container;
a planar-surface mountable barrel-cradle; and
an integrated trigger locking pin
wherein said secure firearm lock system comprises said secure firearm lock assembly;
wherein said secure firearm lock assembly comprises in functional combination said first planar-surface mountable-support, said second planar-surface mountable-support, said at least one locking apparatus, said ammunition storage container, and said planar-surface mountable barrel-cradle;
wherein said ammunition storage container when removably coupled to said first planar-surface mountable-support is structured and arranged to securely and horizontally store ammunition;
wherein said first planar-surface mountable-support further comprises a hinged latch for connection with said barrel lock coupled to said ammunition storage container;
wherein said first planar-surface mountable-support is vertically mounted via fasteners a distance apart from said planar-surface mountable barrel-cradle;
wherein said first planar-surface mountable-support and said second planar-surface mountable-support together form a hingeable yoke such that said first planar-surface mountable-support and said second planar-surface mountable-support are able to move relative to each other between an open and closed position;
wherein said first planar-surface mountable-support comprises padding for supportively-protecting said firearm from damage;
wherein said second planar-surface mountable-support comprises a pad for protecting said firearm from damage;
wherein said hingeable yoke comprises a hinge, a securing arm, and a trigger guard support;
wherein said first planar-surface mountable-support and said second planar-surface mountable-support when closed comprises a integrated trigger locking pin;
wherein said at least one locking apparatus comprises means for securing said ammunition storage container and covering said trigger to prevent use thereof;
wherein said at least one locking apparatus comprises a barrel lock;
wherein said ammunition storage container comprises an inner volume, an outer surface, a top edge, and a bottom edge;
wherein said ammunition storage container is removably couplable to said first planar-surface mountable-support;
wherein said yoke and said planar-surface mountable barrel-cradle are structured and arranged such that a firearm when placed therein can be mounted to a vertical surface for safe storage;
wherein said first planar-surface mountable-support and said second planar-surface mountable-support when closed form a supportive neck to receive said trigger guard of said firearm;
wherein said integrated trigger locking pin comprises a brass rod with a soft plastic tubing to protect said firearm trigger guard and trigger from abrasions;
wherein said first planar-surface mountable-support and said planar-surface mountable barrel-cradle is able to be mounted horizontally and alternately vertically to said common plane;
wherein said planar-surface mountable barrel-cradle comprises a hooked retaining member; and
wherein said secure firearm lock system is structured and arranged for providing ready authorized access to said firearm and said ammunition storage container to an authorized user when needed and safe storage when not needed

18. The secure firearm lock system of claim 17 further comprising a kit including: said first planar-surface mountable-support, said second planar-surface mountable-support, said least one locking apparatus, said ammunition storage container, said planar-surface mountable barrel-cradle, and a set of user instructions.

19. A method of using a secure firearm lock system comprising the steps of:
mounting first planar-surface mountable-support and a second planar-surface mountable-support to a surface;
inserting a firearm to said first planar-surface mountable-support and a second planar-surface mountable-support; and
locking said firearm in place.

20. The method of claim 19 further comprising the step of: locking ammunition into an ammunition storage container.
